(19) United States
(12) Patent Application Publication
(10) Pub. No.: US 2026/0158494 A1
(43) Pub. Date: Jun. 11, 2026

(54) AUTOMATED PRECISION SOLUTION MAKER SYSTEM AND METHOD

(71) Applicant: Owen Zhuang Sun, Torrance, CA (US)

(72) Inventor: Owen Zhuang Sun, Torrance, CA (US)

(21) Appl. No.: 19/226,920

(22) Filed: Jun. 3, 2025

Related U.S. Application Data
(60) Provisional application No. 63/729,395, filed on Dec. 8, 2024.

(51) Int. Cl. B01L 3/00

(52) U.S. Cl. CPC B01L 3/52; B01L 2200/148; B01L 2200/16; B01L 2300/027; B01L 2300/1805; B01L 2400/043

(57) ABSTRACT

A system may include a structural housing. The system may include a magnetic stirring assembly including a built-in scale, a hot plate, and a magnetic stirring base member. The system may include a plurality of funnels including a powder funnel designated for a powdered material and a liquid funnel designated for a liquid material. The powder funnel may include an auger and a motor, where the motor is configured to control a powder flow of the powdered material. The system may include a funnel holder configured to support the plurality of funnels. The system may include one or more diaphragms positioned below each funnel of the plurality of funnels, where the one or more diaphragms includes an adjustable opening and a diaphragm motor, and where the one or more diaphragms are configured to regulate a discharge of the one or more materials through the adjustable opening.

### CROSS-REFERENCE TO RELATED APPLICATIONS

The present application claims the benefit under 35 U.S.C. § 119 (e) of U.S. Provisional Application No. 63/729,395, filed Dec. 8, 2024, which is herein incorporated by reference in the entirety.

### BACKGROUND

In many laboratory settings, preparing solutions that involve both powders and liquids is a time-consuming and error-prone process, typically requiring manual weighing of each component followed by manual mixing.

### SUMMARY

In embodiments, an automated solution maker system including: a structural housing including at least one of a base, a top lid, one or more side casings, a front casing, and a back casing, where the base of the structural housing is configured to receive a solution collection vessel; a magnetic stirring assembly, where the magnetic stirring assembly includes a built-in scale configured to weigh one or more materials within the solution collection vessel, where the magnetic stirring assembly includes a hot plate configured to heat the one or more materials within the solution collection vessel, where the magnetic stirring assembly includes a magnetic stirring base member disposed on the base; a plurality of funnels, where the plurality of funnels include at least one powder funnel designated for a powdered material and at least one liquid funnel designated for a liquid material, where the at least one powder funnel includes an auger and a motor, where the motor of the at least one powder funnel is configured to control a powder flow of the powdered material; a funnel holder configured to support the plurality of funnels, where the funnel holder is mounted to a portion of the structural housing; one or more diaphragms positioned below each funnel of the plurality of funnels, where the one or more diaphragms includes an adjustable opening and a diaphragm motor, where the one or more diaphragms are configured to regulate a discharge of the one or more materials through the adjustable opening; and one or more controllers communicatively coupled to the magnetic stirring assembly and the one or more diaphragms, where the one or more controllers include a proportional-integral-derivative (PID) algorithm stored in memory, where the one or more controllers include one or more processors configured to execute a set of program instructions causing the one or more processors to: receive one or more solution parameters; generate one or more control signals configured to cause the adjustable opening of the one or more diaphragms to open a predetermined amount; receive a real-time weight of the one or more materials within the solution collection vessel; and generate one or more control signals configured to cause the magnetic stirring assembly to mix the one or more materials within the solution collection vessel.

In embodiments, an automated solution maker system including: a structural housing including at least one of a base, a top lid, one or more side casings, a front casing, and a back casing, where the base of the structural housing is configured to receive a solution collection vessel, a magnetic stirring assembly, where the magnetic stirring assembly includes a built-in scale configured to weigh one or more materials within the solution collection vessel, where the magnetic stirring assembly includes a hot plate configured to heat the one or more materials within the solution collection vessel, where the magnetic stirring assembly includes a magnetic stirring base member disposed on the base; a plurality of funnels, where the plurality of funnels include at least one powder funnel designated for a powdered material and at least one liquid funnel designated for a liquid material, where the at least one powder funnel includes an auger and a motor, where the motor of the at least one powder funnel is configured to control a powder flow of the powdered material; a funnel holder configured to support the plurality of funnels, where the funnel holder is mounted to a portion of the structural housing; and one or more diaphragms positioned below each funnel of the plurality of funnels, where the one or more diaphragms include an adjustable opening and a diaphragm motor, where the one or more diaphragms are configured to regulate a discharge of the one or more materials through the adjustable opening.

In embodiments, a method including: receiving one or more user inputs, where the one or more user inputs includes one or more solution parameters, where the one or more solution parameters include at least one of a powder mass, PID algorithm constants, an auger speed, a bulk density, a screw geometry, a material compressibility, a predetermined mass, a predetermined volume, a fluid density, a viscosity, or one or more funnel dimensions; dispensing, individually, one or more materials within a plurality of funnels into a solution collection vessel, where the plurality of funnels include at least one powder funnel designated for a powdered material and at least one liquid funnel designated for a liquid material, where the at least one powder funnel includes an auger and a motor, where the motor of the at least one powder funnel is configured to control a powder flow of the powdered material; weighing, individually, the one or more materials dispensed in the solution collection vessel using a built-in scale of a magnetic stirring assembly; activating a magnetic stirrer of the magnetic stirring assembly; and performing a closed-loop control using a proportional-integral-derivative algorithm stored in memory based on real-time mass feedback from the built-in scale to dynamically adjust one of an aperture size of an adjustable opening or an auger speed of the auger of the at least one powder funnel.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The individual components of the apparatus can be better understood by referring to the accompanying figures in which:

FIG. 1A is an elevational front view of an automated solution-maker, in accordance with one or more embodiments of the present disclosure.

FIG. 1B is an elevational rear view of an automated solution-maker, in accordance with one or more embodiments of the present disclosure.

FIG. 2 is an isometric view of the automated solution-maker, in accordance with one or more embodiments of the present disclosure.

FIG. 3 is an exploded view of the automated solution-maker, in accordance with one or more embodiments of the present disclosure.

FIG. 4 is an isometric view of four servo-controlled switches of the automated solution-maker, in accordance with one or more embodiments of the present disclosure.

FIG. 5 is an exploded view of four funnels, funnel holder, and the four servo-controlled switched, in accordance with one or more embodiments of the present disclosure.

FIG. 6 is an exploded view of a funnel designated for powder, in accordance with one or more embodiments of the present disclosure.

FIG. 7 is an exploded view of a funnel designated for fluid, in accordance with one or more embodiments of the present disclosure.

FIG. 8 is an isometric view of a motorized iris diaphragm, in accordance with one or more embodiments of the present disclosure.

FIG. 9 is a flow chart depicting a method for using the automated solution-maker, in accordance with one or more embodiments of the present disclosure.

FIG. 10 is a flow chart depicting a method for dispensing powder, in accordance with one or more embodiments of the present disclosure.

FIG. 11 is a flow chart depicting a method for dispensing fluid, in accordance with one or more embodiments of the present disclosure.

FIG. 12 is a circuit diagram of the automated solution-maker, in accordance with one or more embodiments of the present disclosure.

### DETAILED DESCRIPTION

Reference will now be made in detail to the subject matter disclosed, as illustrated in the accompanying drawings.

Embodiments of the present disclosure are directed to an automated solution-making apparatus capable of dispensing and mixing precise quantities of powders and liquids through programmable controls. The apparatus may be configured to allow for precise, automated, and repeatable solution preparation, making it suitable for environments requiring high dosing accuracy and programmable workflows. For example, the apparatus may include a plurality of funnels including one or more funnels designated for powders and one or more funnels designated for liquids, where each funnel is equipped with a motorized iris diaphragm configured to regulate the opening size and timing of material flow. The powder funnels may further be integrated with one or more motorized auger assemblies. In this regard, the one or more motorized auger assemblies of the powder funnels may be configured to enable controlled mechanical discharge and reduce dependence on gravity. The liquid funnels may rely on gravity-driven flow regulated by orifice dimensions and fluid properties.

Central to the apparatus is a magnetic stirrer with an integrated scale and hot plate, which provides heating, mixing, and real-time mass feedback. This feedback is processed through a Proportional-Integral-Derivative (PID) control algorithm, thus enabling dynamic adjustments during dispensing to maintain dosing accuracy. The apparatus may include a user interface (e.g., a touchscreen liquid crystal display (LCD)) and a controller including one or more processors configured to dispense the powders and liquids based on the provided PID control algorithm based on one or more user inputs and physical parameters received via the user interface. For powders, the system may consider PID algorithm constants, screw pitch, outer diameter, and shaft diameter of the auger, auger speed, and bulk density, fill efficiency, and compressibility of the powder. For liquids, the system may account for the dimensions of the inverted cone funnel (e.g., mouth and neck diameters, height), PID algorithm constants, initial fluid height, and the liquid's density.

It is contemplated herein that the apparatus of the present disclosure may ensure high precision, consistency, and reduced manual effort, making it ideal for environments that require frequent and accurate solution preparation.

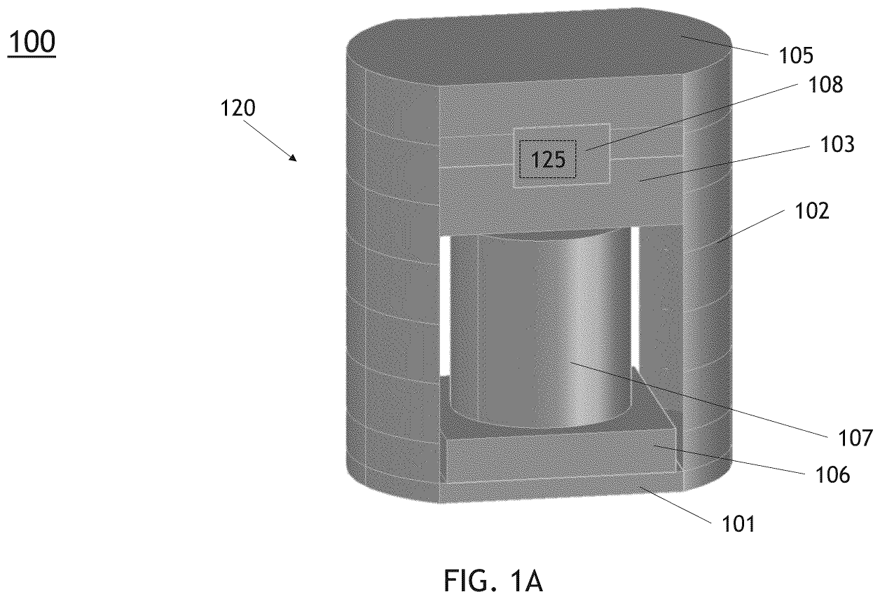

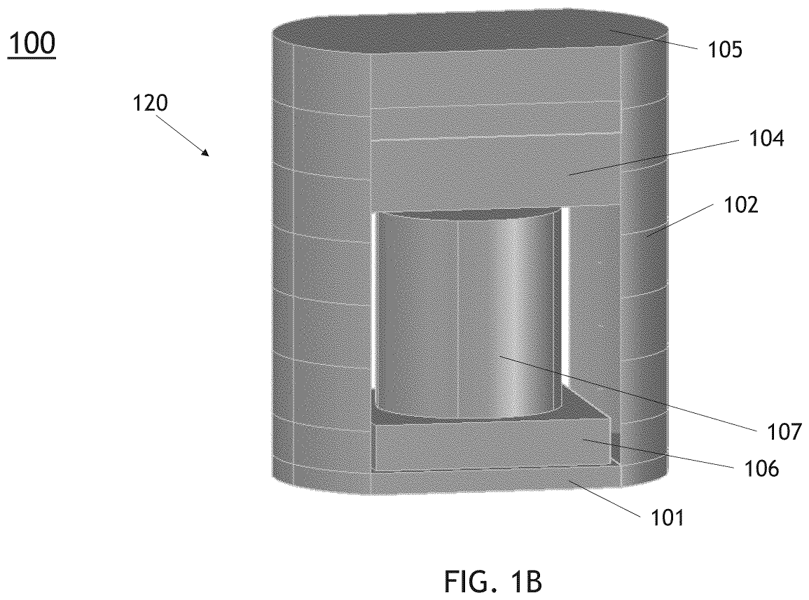

Referring generally to FIGS. 1A through 8, an automated solution-maker system 100 is shown, in accordance with one or more embodiments of the present disclosure.

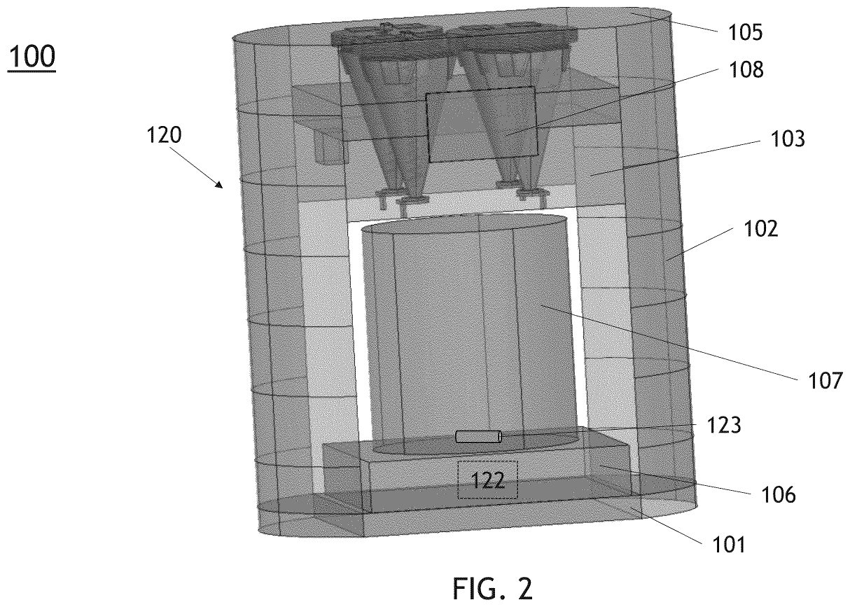

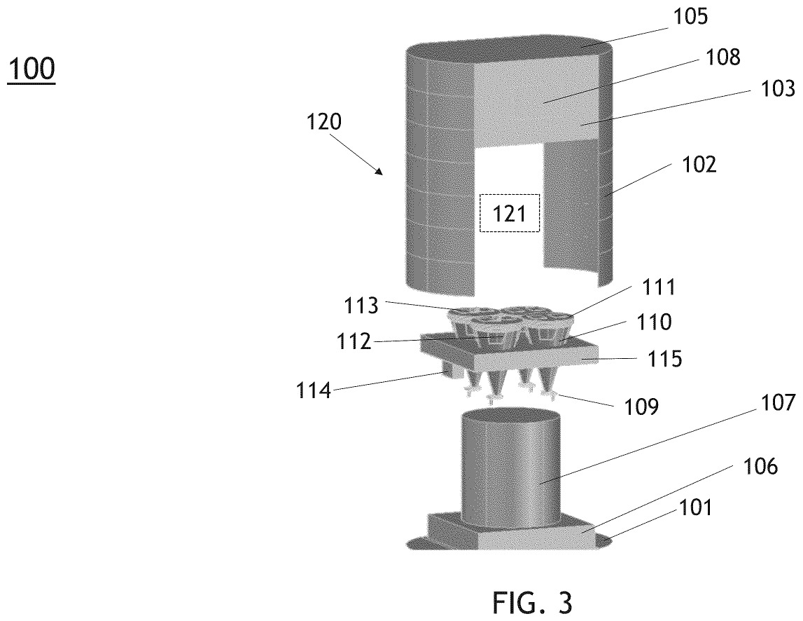

FIGS. 1A-1B are elevational views of the solution maker 100, in accordance with one or more embodiments of the present disclosure. FIG. 2 is an isometric view of the solution maker 100, in accordance with one or more embodiments of the present disclosure. FIG. 3 is an exploded view of the solution maker 100, in accordance with one or more embodiments of the present disclosure.

The solution maker 100 includes a structural housing 120 (or outer casing). For example, the structural housing 120 (or outer casing) may include, but is not limited to, a base 101, one or more side casings 102 (e.g., a left side casing 102 and a right casing 102), a front casing 103, a back casing 104, and a top lid 105. Referring to FIG. 3, the side casings 102 (e.g., coupled to the front casing 103 and the back casing 104) may be removably coupled to the base 101.

The solution maker 100 is configured to receive a solution collection vessel 107. For example, the structural housing 120 may at least partially define a cavity 121 configured to receive the solution collection vessel 107. The solution collection vessel 107 may include any suitable collection vessel including, but not limited to, a beaker, cylinder, or the like.

The solution maker 100 includes a mixing assembly 106. For example, the mixing assembly 106 may include a magnetic stirring assembly. The magnetic stirring assembly may include a magnetic base member 122 and a magnetic stirring bar 123. The magnetic stirring bar 123 may be immersed in a solution within the solution collection vessel 107 and be configured to mix the contents within the solution collection vessel 107. For example, the magnetic stirring bar 123 may be driven by a rotating magnetic field generated between the stirring bar 123 and a magnet within the magnetic base member 122. For instance, as the magnetic field rotates, it causes the magnetic stirring bar 123 to spin rapidly within the liquid. In this regard, the spinning action creates a vortex that effectively mixes the liquid, ensuring uniform distribution and homogeneity.

The magnetic base member 122 may be positioned proximate to the base 101. For example, the magnetic base member 122 may be disposed on the base 101. For instance, the magnetic base member 122 may be configured to hold the solution collection vessel 107.

The magnetic base member may include a built-in scale. For example, the built-in scale may be configured to measure the weight of the solution vessel 107 and/or contents within the solution vessel 107. In this regard, the respective weight may be displayed on a user interface device 108, as will be discussed further herein.

The magnetic base member 122 may further include a hot plate. For example, the hot plate may be configured to heat contents within the solution vessel 107. In this regard, the contents of the solution vessel 107 may be heated to allow for homogeneous mixing/stirring.

The solution maker 100 includes a user interface device 108 configured to receive one or more user inputs. For example, the user interface 108 may include a touchscreen display 108 (e.g., liquid crystal display (LCD)) configured to display one or more graphical user interfaces (GUIs)). For instance, the touchscreen display 108 may be mounted on a portion of the front casing 103 and be configured to display the one or more GUIs.

Although FIG. 1A depicts the touchscreen display 108 being positioned on the front casing 103, it is contemplated herein that the touchscreen display 108 may be positioned on any portion of the structural housing or other portion of the solution maker 100 (e.g., the magnetic base member 122, or the like). Further, it is contemplated herein that the user interface device 108 may be external to the solution maker 100, such that the controller 114 may be communicatively coupled to a remote user interface device 108 (e.g., a user mobile device, or the like).

The touchscreen display 108 may include one or more selectable buttons 125. For example, the touchscreen display 108 may be configured to receive one or more user inputs via the one or more selectable buttons.

The one or more user inputs may include one or more solution parameters. For example, the one or more solution parameters may include, but are not limited to, powder or liquid material names, powder mass, auger speed, bulk density, screw geometry, liquid volume, mass, density, funnel dimensions, or the like.

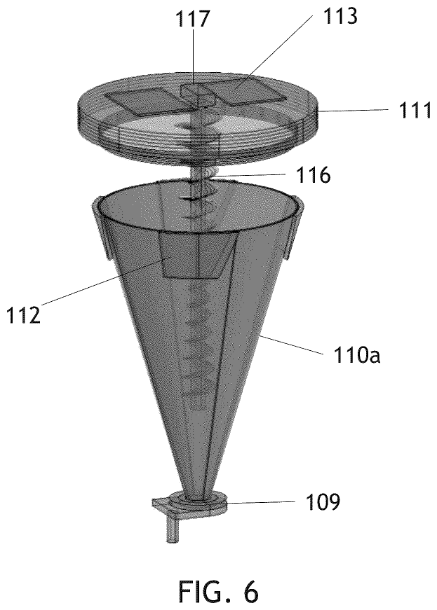

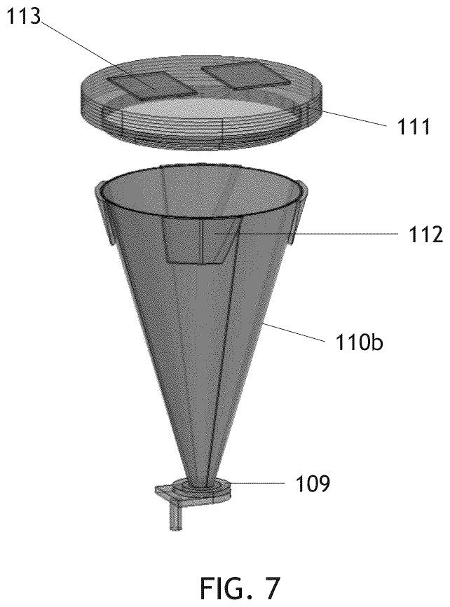

The solution maker 100 includes a plurality of funnels 110. For example, the plurality of funnels 110 may include one or more powder funnels 110a designated for receiving/dispensing one or more powders (as shown in FIG. 6) and one or more liquid funnels 110b designated for receiving/dispensing one or more liquids (as shown in FIG. 7). In a non-limiting example, as shown in FIGS. 3-5, the solution maker 100 includes four funnels 110 including two powder funnels 110a and two liquid funnels 110b. It is contemplated herein that the solution maker 100 may include any number and/or configuration of funnels 110, however, it is advantageous that the solution maker 100 include at least one powder funnel 110a and one liquid funnel 110b.

The solution maker 100 may include a funnel holder 115 coupled to a portion of the structural housing 120. For example, the funnel holder 115 may support (or hold) the plurality of funnels 110 and couple at least a portion of the front casing 103 and/or the back casing 104.

The top lid 105 of the structural housing 120 may be configured to open such that the plurality of funnels 110 and/or the funnel holder 115 may be accessed. For example, the top lid 105 may include a rotation mechanism (e.g., hinge mechanism), such that the lid 105 may be rotated between one of an open position and a closed position.

Each funnel 110 may be configured to couple to a lid 111. The lid 111 may include a magnetic lid. For example, the magnetic lid 111 may include one or more magnetic sheets 113. For instance, in a non-limiting example, each lid 111 may include two magnetic sheets 113. Further, each funnel 110 may include one or more magnetic sheets 112 coupled to an exterior surface (or outer surface) of the respective funnel 110. For instance, in a non-limiting example, each funnel 110 may include four magnetic sheets 112 arranged on the outer surface of the funnel 110. In this regard, the funnel 110 may be configured for robotic pickup via the one or magnetic sheets 113 on the lid 111 and the one or more magnetic sheets 112 on the funnel 110.

Referring to FIG. 6, each powder funnel 110a may include an auger 116 and a motor 117. For example, the auger 116 and the motor 117 may be integrated into the funnel lid 111. For instance, the auger 116 and the motor 117 may be coupled to the lid 111 of the funnel 110a. In this regard, the auger 116 and the motor 117 may be configured to facilitate smooth powder flow. As previously mentioned herein, a user may input a desired auger speed into the touchscreen display 108, such that the controller 114 of the solution maker 100 may control the respective speed of the motor 117 and/or auger 116.

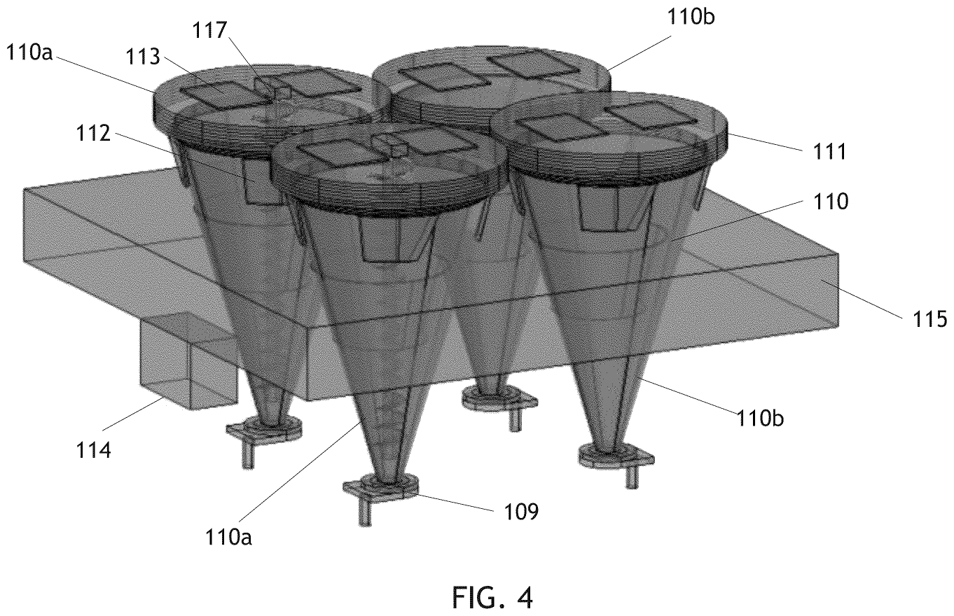

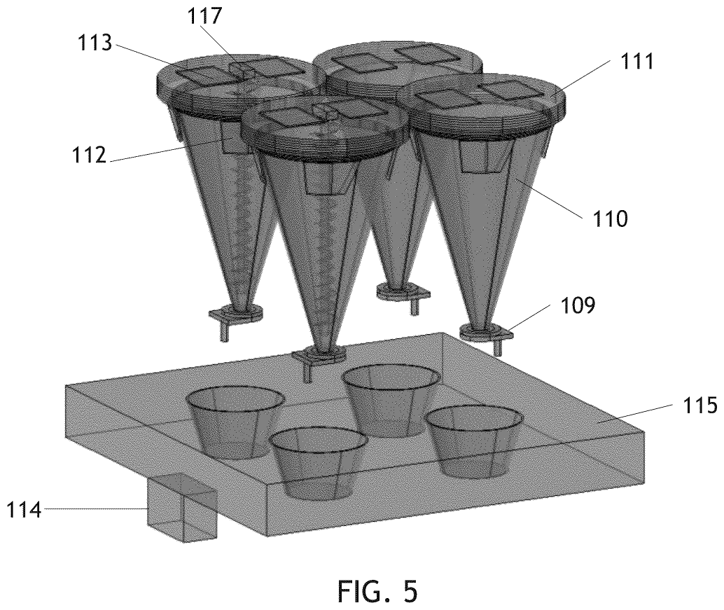

The solution maker 100 includes a plurality of motorizing diaphragms 109. For example, the plurality of motorizing diaphragms 109 may be coupled to an end of the plurality of funnels 110. In this regard, the plurality of motorizing diaphragms 109 may be configured to control dispensing of one or more materials through the respective funnels 110 (e.g., powder from the powder funnels 110a and/or liquid from the liquid funnels 110b). In a non-limiting example, as shown in FIGS. 4 and 5, the solution maker 100 may include four motorized iris diaphragms 109 configured to control the dispensing of materials from the four funnels 110.

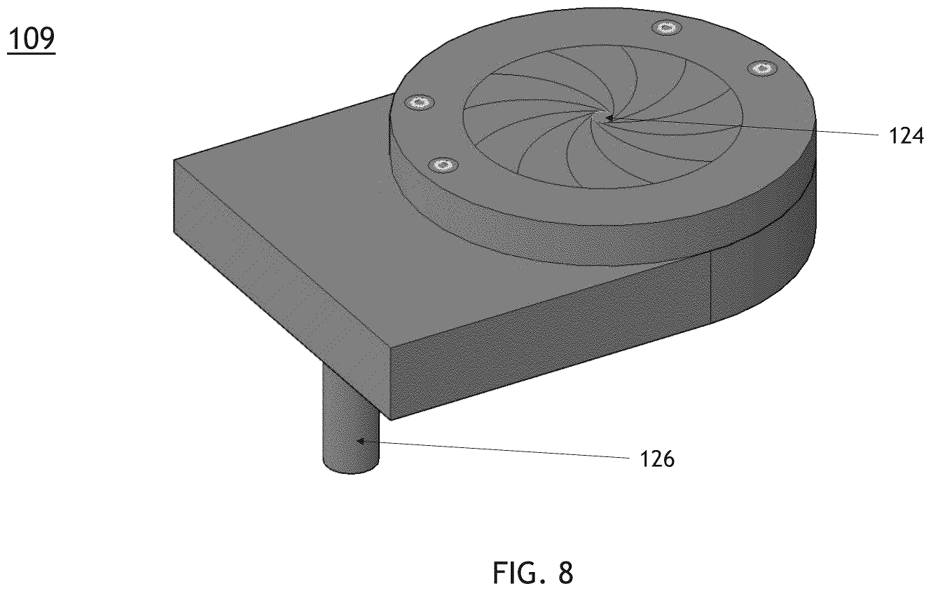

Referring to FIG. 8, each motorized diaphragm 109 may include an adjustable opening nozzle 124 and electric motor 126 (or actuator). The adjustable opening nozzle 124 may include one or more overlapping blades arranged in a circular pattern to form a symmetric iris configured to open and close to adjust the aperture diameter. For example, the electric motor 126 may be configured to actuate (e.g., rotate) to cause the one or more overlapping blades of the adjustable opening nozzle 124 to open (and/or close) based on a specific material flow, as will be discussed further herein. It is contemplated herein that the opening nozzle 124 may have a minimum opening of 0 inch and a maximum opening up to 2 inches.

The electric motor 126 may include any type of actuator such as, but not limited to, a servo motor, or the like.

The solution maker 100 includes a controller 114. The controller 114 may include a computer (e.g., Raspberry Pi). For example, as shown in FIG. 4, the controller 114 may be mounted on the bottom face of the funnel holder 115. The controller 114 may include one or more processor and a memory. The one or more processors may be configured to execute a set of program instructions stored in the memory.

Each motorized iris diaphragm 109 may be communicatively coupled to the controller 114. For example, the controller 114 may be configured to adjust the opening diameter of the motorized diaphragm 109. For instance, the motorized diaphragm 109, via the controller 114, may be configured to precisely regulate the size of the opening of the adjustable opening nozzle 124 to ensure a controlled material flow dependent on the PID control algorithm. For example, the motor 126 may be configured to receive one or more commands from the controller 114 that determines flow from funnels based on one or more pre-programmed parameters associated with the opening nozzle 124. For instance, upon activation, the motor 126 may be configured to adjust the opening nozzle 124 to cause it to fully open (e.g., to a two-inch diameter), allowing a specified amount of material to be dispensed from the respective funnel 110.

Once material dispensing begins, the system 100 may rely on real-time feedback mechanisms to ensure precise formulation and control. For example, the magnetic stirring assembly 106 may be configured to provide real-time mass feedback, via the built-in scale, for PID algorithmic control, while maintaining the heating and mixing capabilities needed for solution preparation.

The PID algorithm may be stored in memory on the controller 114 and may enable real-time monitoring and dynamic adjustments, using three components. For example, the PID algorithm may be based on Proportional (P), which corrects immediate errors; Integral (I), which eliminates steady-state errors; and Derivative (D), which predicts future errors and smooths fluctuations. Variations in the iris diaphragm opening 124 may allow fine-tuned weight adjustments based on feedback from the built-in scale of the stirring assembly 106. It is contemplated herein that the automated solution maker system 100 may be configured to operate across the plurality of funnels 110, thus enabling accurate dosing of both powders and liquids via the respective funnels 110a, 110b.

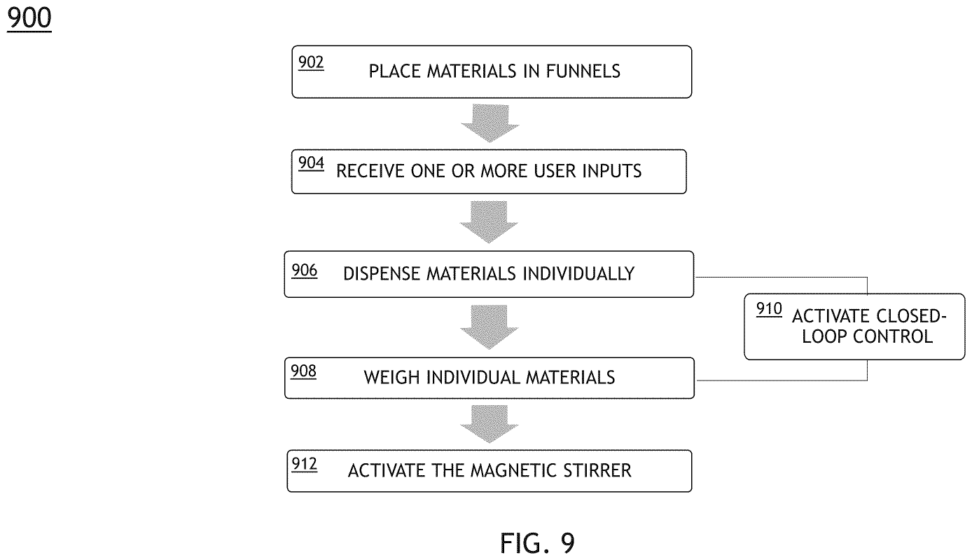

FIG. 9 is a flow chart depicting a method 900 for operating the solution maker 100, in accordance with one or more embodiments of the present disclosure.

In a step 902, one or more materials may be placed in the one or more funnels. For example, one or more powders may be placed in the one or more funnels. By way of another example, one or more liquids may be placed the one or more funnels.

In a step 904, one or more user inputs may be received. For example, the one or more user inputs may be received via the user interface device 108. The one or more user inputs may include the one or more solution parameters (e.g., powder mass, auger speed, bulk density, screw geometry, liquid volume, mass, density, funnel dimensions, or the like).

In a step 906, one or more materials may be dispensed. For example, each individual funnel 110 may dispense a material into the solution vessel 107. For instance, the one or more powder funnels 110a may individually dispense the respective powders into the solution vessel 107 and the one or more liquid funnels 110b may individually dispense the respective liquids into the solution vessel 107.

In a step 908, the dispensed materials may be individually weighed. For example, after each funnel 110 dispenses the respective material into the solution collection vessel 107, the built-in scale of the magnetic stirring assembly 106 may be configured to individually weigh the respective material. In this regard, the respective weight may be displayed on the touchscreen display 108 of the solution maker 100.

In a step 910, the PID control loop may be activated. For example, the controller 114 may be configured to perform real-time monitoring and dynamic adjustments, using the PID algorithm stored in memory. For instance, the controller 114 may be configured to receive a weight of the respective individual materials and cause a respective funnel 110 to dispense a particular amount of material by adjusting the opening diameter of the motorized iris diaphragm (e.g., by rotating the overlapping blades). In this regard, accurate dosing of both powders and liquids via the respective funnels 110a, 110b may be enabled via the PID algorithm stored in memory on the controller 114.

In a step 912, the magnetic stirring assembly may be activated. For example, the magnetic stirring bar may be placed within the solution vessel 107 to activate the stirring assembly.

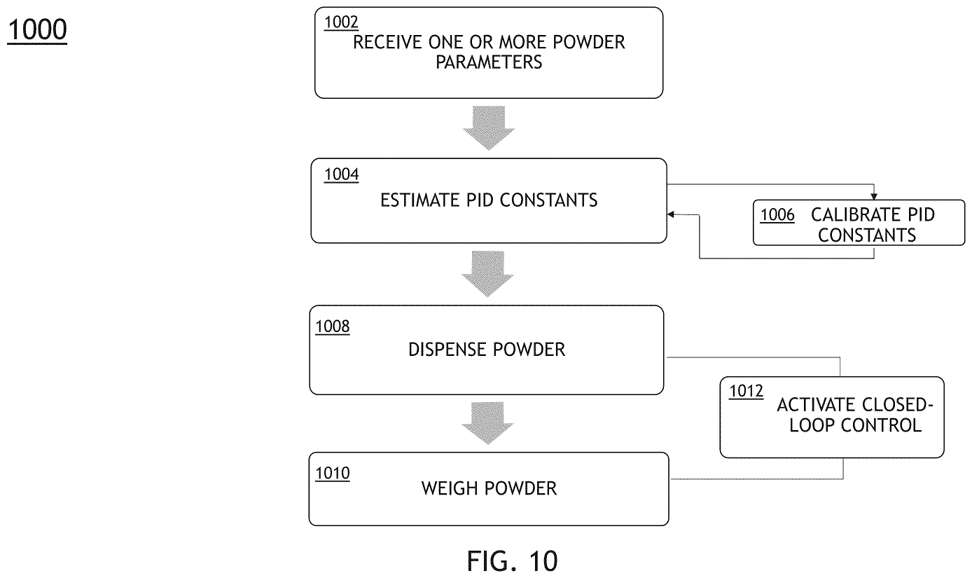

FIG. 10 presents a flowchart depicting a method 1000 for powder discharge, in accordance with one or more embodiments of the present disclosure. It is contemplated herein that one or more components of the system 100 may perform one or more steps of the method 1000. For example, the system 100 may be configured to provide a controlled powder discharge mechanism using a funnel-based flow integrated with an auger assembly. In this regard, the auger may regulate the discharge rate through mechanical actuation, reducing dependence on gravity. For example, the discharge characteristics may include the screw pitch, outer diameter, and shaft diameter of the auger, auger speed, and bulk density, fill efficiency, and compressibility of the powder.

In a step 1002, one or more powder parameters may be received. For example, the controller 114 may receive one or more powder solutions parameters via the touchscreen display 108. For instance, at least one of powder mass, auger speed, bulk density, or screw geometry may be inputted into the touchscreen display 108 via one or more selectable buttons and provided to the controller 114.

In a step 1004, one or more PID algorithm constants may be determined. For example, the PID algorithm constants, Kₚ, Kᵢ, and K_{d}, may be determined through iterative empirical trials for each individual powders and provided to the controller 114 respectively.

The overall control function is shown and described by Equation 1 below:

$$u ( t ) = {K}_{p} e ( t ) + {K}_{i} {\int }_{0}^{t} e ( τ ) d τ + {K}_{d} \frac{de ( t )}{dt} , \qquad Equation 1$$

where Kₚ, Kᵢ, and K_{d} denote the coefficients for the proportional, integral, and derivative terms, respectively, e(t) is the function of the error between the setpoint and process variable, t is the variable of integration, and t is the time or instantaneous time. It is contemplated herein that while the PID constants dictate the system's dynamic response, the actual flow time may be influenced by mechanical design features and material characteristics, including the screw pitch, outer diameter, and shaft diameter of the auger, auger speed, and bulk density, fill efficiency, and compressibility of the powder. To facilitate the dispensing of various materials, one or more PID constants may be determined through empirical trials for each material and stored in memory on the controller 114. It is contemplated herein that this library/database (or look-up table) may streamline the dispensing process by automatically displaying suggested PID constants on the touchscreen LCD 108 based on the input dosage.

In a step 1006, the PID constants may be calibrated. For example, the PID constants may be calibrated by selecting the PID algorithm tuning method via the touchscreen LCD 108. The tuning methods include automatic and/or manual options, including, but not limited to, Lambda Internal Model Control tuning with setpoint ramping. The LCD 108 may display step-by-step instructions on achieving optimal PID constants for the user, allowing for seamless acquisition of PID constants while preventing overshoot that could result in excess material being released into the hopper.

In a step 1008, a respective powder may be dispensed. For example, the funnel 110a may be configured to dispense the respective powder. For instance, the controller 114 may be configured to cause the adjustable nozzle opening 124 of the diaphragm 109 to open, such that the respective powder may be dispensed from the funnel 110a.

In a step 1010, the dispensed powder may be weighted. For example, the built-in scale of the magnetic stirring assembly 106 may be configured to measure the respective powder in the solution vessel 107.

In a step 1012, the PID control loop may be activated. For example, the controller 114 may be configured to perform real-time monitoring and dynamic adjustments, using the PID algorithm stored in memory. For instance, the controller 114 may be configured to receive the weight of the respective powder material and cause a respective funnel 110 to dispense a particular amount of powder. In this regard, accurate dosing of the powder via the respective funnels 110a may be enabled via the PID algorithm stored in memory on the controller 114.

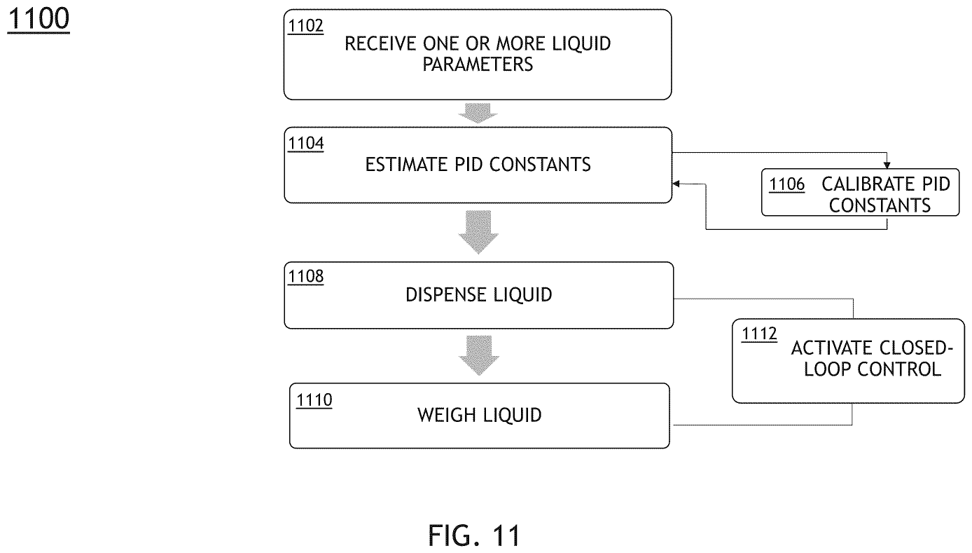

FIG. 11 presents a flowchart depicting a method 1100 for dispensing a liquid, in accordance with one or more embodiments of the present disclosure. It is contemplated herein that one or more components of the system 100 may perform one or more steps of the method 1100. For example, the system 100 may be configured to provide a controlled liquid discharge mechanism using a funnel-based flow.

In a step 1102, one or more liquid parameters may be received. For example, the controller 114 may receive one or more liquid solutions parameters via the touchscreen display 108. For instance, at least one of liquid volume, mass, density, or funnel dimensions may be inputted into the touchscreen display 108 via one or more selectable buttons and provided to the controller 114.

In a step 1104, one or more PID algorithm constants may be determined. For example, the PID algorithm constants, Kₚ, Kᵢ, and K_{d}, may be determined through iterative empirical trials for each individual powders and provided to the controller 114 respectively (using Equation 1, shown and described above). It is contemplated herein that while the PID constants dictate the system's dynamic response, the actual flow time is influenced by funnel geometry and material properties, including the dimensions of the inverted cone funnel (e.g., funnel mouth and neck diameters, height), initial fluid height, and the liquid's density and viscosity. To facilitate the dispensing of various liquids, a library of recommended PID constants will be developed through empirical trials across a range of dosages for each material. This library will enhance efficiency by automatically displaying suggested PID constants on the touchscreen LCD based on the input dosage.

In a step 1106, the PID constants may be calibrated. For example, the PID constants may be calibrated by selecting the PID algorithm tuning method via the touchscreen LCD 108. The tuning methods include automatic and/or manual options, including, but not limited to, Lambda Internal Model Control tuning with setpoint ramping. The LCD 108 may display step-by-step instructions on achieving optimal PID constants for the user, allowing for seamless acquisition of PID constants while preventing overshoot that could result in excess material being released into the hopper.

In a step 1108, a respective liquid may be dispensed. For example, the funnel 110b may be configured to dispense the respective liquid. For instance, the controller 114 may be configured to cause the adjustable opening 124 of the diaphragm 109 to open, such that the respective liquid may be dispensed from the funnel 110b.

In a step 1110, the dispensed liquid may be weighted. For example, the built-in scale of the magnetic stirring assembly 106 may be configured to measure the respective liquid in the solution vessel 107.

In a step 1112, the PID control loop may be activated. For example, the controller 114 may be configured to perform real-time monitoring and dynamic adjustments, using the PID algorithm stored in memory. For instance, the controller 114 may be configured to receive the weight of the respective liquid and cause a respective funnel 110b to dispense a particular amount of liquid. In this regard, accurate dosing of the liquid via the respective funnels 110b may be enabled via the PID algorithm stored in memory on the controller 114.

A non-limiting illustrative example of preparing a 1% agarose gel solution for gel electrophoresis is described below. This solution consists of 1 g of agarose powder and 100 ml of Tris-Acetate-EDTA (TAE) buffer. The procedure is summarized for demonstration purposes using assumed input values.
Step 1: Place the agarose powder in funnel 110a and the TAE buffer in funnel 110b.
Step 2: On the touchscreen LCD 108, the primary parameters may be inputted. In a non-limiting example, the interface 108 may allow entry for up to four materials (e.g., two powders, two liquids).
Select the first powder and enter:
Name: agarose
Target mass: 1 g
Bulk density: 0.5 g/cm³
Auger speed: 60 RPM
Auger screw pitch: default
Auger outer diameter: default
Mouth diameter of the inverted cone funnel: default
Neck diameter of the inverted cone funnel: default
Height of the inverted cone funnel: default
Step 3: Input the PID constants based on the suggested values on the touchscreen LCD 108 from the library of materials or estimate PID constants.
Step 4: Dispense the agarose via the funnel 110a.
Step 5: The dispensed agarose may be weighed in solution vessel 107 using the built-in scale of magnetic stirring assembly 106. The real-time mass may be displayed on the LCD 108, and the PID control loop of the controller 114 may be configured to perform real-time monitoring and dynamic adjustments. It is noted herein that dispensing may stop automatically once the target mass is reached.
Step 6: Similar to Step 2, On the LCD 108, select the first liquid and input:
Name: Tris-Acetate-EDTA (TAE) buffer
Density: 1.01 g/mL
Target mass: 101 g
Step 7: Similar to Step 2 for agarose, input the suggested PID constants based on the suggested values on the touchscreen LCD 108 via the one or more selectable buttons.
Step 8: Dispense the TAE buffer via the funnel 110b.
Step 9: The dispensed TAE buffer may be weighed in vessel 107 using the built-in scale 106. The mass may be shown in real time on the LCD 108, with PID control enabled for real-time adjustments. Dispensing stops automatically once the target mass is reached.
Step 10: Mix and boil the solution to make agarose gel.

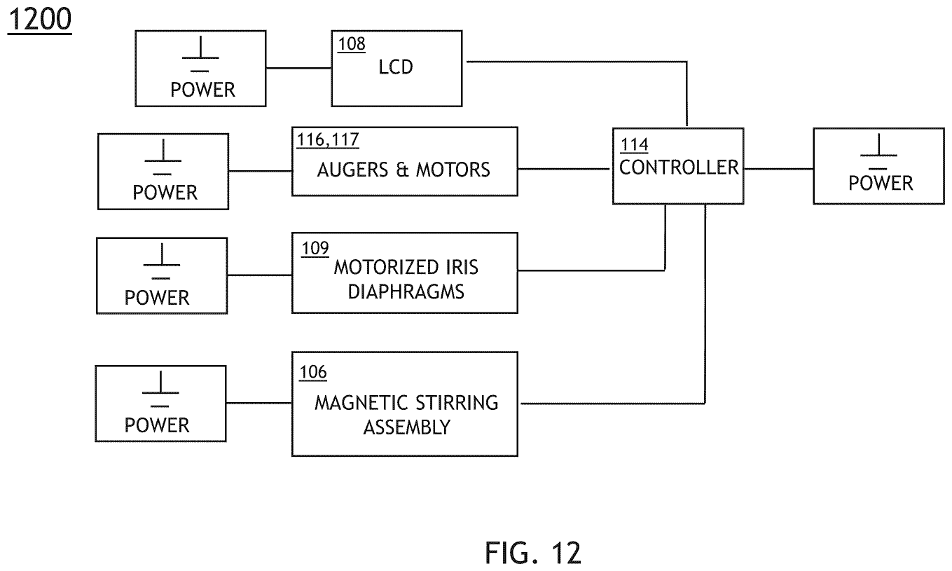

FIG. 12 illustrates a circuit diagram 1200 of the solution maker 100, in accordance with one or more embodiments of the present disclosure. For example, the circuit diagram 1200 depicts the magnetic stirrer with a built-in scale and hot plate, touchscreen LCD 108, motorized iris diaphragms 109, controller 114 (e.g., Raspberry Pi), and augers 116 with their motors 117. It is contemplated herein that one or more components of the solution maker may be communicatively coupled to the controller 114, where their respective operations may be controlled by the programmed software stored in memory on the controller 114.

The one or more processors may include any one or more processing elements known in the art. In this sense, the one or more processors may include any microprocessor device configured to execute algorithms and/or program instructions. In general, the term “processor” may be broadly defined to encompass any device having one or more processing elements, which execute a set of program instructions from a non-transitory memory medium (e.g., the memory), where the one or more sets of program instructions are configured to cause the one or more processors to carry out any of one or more process steps.

The memory may include any storage medium known in the art suitable for storing the one or more sets of program instructions executable by the associated one or more processors. For example, the memory may include a non-transitory memory medium. For instance, the memory may include, but is not limited to, a read-only memory (ROM), a random access memory (RAM), a magnetic or optical memory device (e.g., disk), a magnetic tape, a solid state drive, and the like. The memory may be configured to provide display information to the user device. In addition, the memory may be configured to store user input information from one or more user input devices. The memory may be housed in a common controller housing with the one or more processors. The memory may, alternatively or in addition, be located remotely with respect to the spatial location of the processors and/or the one or more controllers 114. For instance, the one or more processors, the one or more controllers 114 may access a remote database, accessible through a network (e.g., internet, intranet, and the like) via one or more communication interfaces.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

1. An automated solution maker system comprising:
a structural housing including at least one of a base, a top lid, one or more side casings, a front casing, and a back casing, wherein the base of the structural housing is configured to receive a solution collection vessel;
a magnetic stirring assembly, wherein the magnetic stirring assembly includes an integrated scale within a housing of the magnetic stirring assembly, wherein the integrated scale is configured to weigh one or more materials within the solution collection vessel, wherein the magnetic stirring assembly includes a hot plate configured to heat the one or more materials within the solution collection vessel, wherein the magnetic stirring assembly includes a magnetic stirring base member disposed on the base;
a plurality of funnels positioned to dispense directly into the solution collection vessel, wherein the plurality of funnels include at least one powder funnel designated for a powdered material and at least one liquid funnel designated for a liquid material, wherein the at least one powder funnel includes an auger and a motor, wherein the motor of the at least one powder funnel is configured to control a powder flow of the powdered material;
a funnel holder configured to support the plurality of funnels, wherein the funnel holder is mounted to a portion of the structural housing;
one or more diaphragms positioned below each funnel of the plurality of funnels, wherein the one or more diaphragms includes an adjustable opening and a diaphragm motor, wherein the one or more diaphragms are configured to regulate a discharge of the one or more materials through the adjustable opening; and
one or more controllers communicatively coupled to the magnetic stirring assembly and the one or more diaphragms, wherein the one or more controllers include a proportional-integral-derivative (PID) algorithm stored in memory, wherein the one or more controllers include one or more processors configured to execute a set of program instructions causing the one or more processors to:
receive one or more solution parameters;
generate one or more control signals configured to cause the adjustable opening of the one or more diaphragms to open a predetermined amount;
receive a real-time weight of the one or more materials within the solution collection vessel from the integrated scale of the magnetic stirring assembly;
perform a closed-loop control using the PID algorithm stored in the memory based on the real-time weight from the integrated scale to dynamically adjust an aperture size of the adjustable opening of the at least one powder funnel, wherein the PID algorithm compares the real-time weight of the one or more materials to a target mass received as one of the one or more solution parameters and generates one or more PID control signals to the diaphragm motor of the one or more diaphragms to regulate the aperture size of the adjustable opening, wherein dispensing through the adjustable opening stops automatically when the real-time weight of the one or more materials reaches the target mass; and
generate one or more control signals configured to cause the magnetic stirring assembly to mix the one or more materials within the solution collection vessel, wherein the one or more controllers are configured to receive the real-time weight from the integrated scale of the magnetic stirring assembly while the magnetic stirring assembly simultaneously maintains mixing of the one or more materials within the solution collection vessel.

2. The automated solution maker system of claim 1, wherein the one or more controllers are further configured to:
dispense the powdered material based on the PID algorithm, wherein the PID algorithm is based on the one or more solution parameters received, wherein the one or more solution parameters received include at least one of a powder mass, PID constants, an auger speed, a bulk density, and a screw geometry.

3. The automated solution maker system of claim 1, wherein the one or more controllers are further configured to:
dispense the liquid material based on the PID algorithm, wherein the PID algorithm is based on the one or more solution parameters received, wherein the one or more solution parameters received include at least one of a predetermined mass, PID constants, a predetermined volume, a fluid density, or one or more funnel dimensions.

4. (canceled)

5. The automated solution maker system of claim 1, wherein each funnel of the plurality of funnels includes a removable lid.

6. The automated solution maker system of claim 5, wherein the removable lid includes one or more magnetic sheets arranged to allow for robotic pickup.

7. The automated solution maker system of claim 6, wherein each funnel of the plurality of funnels includes one or more additional magnetic sheets arranged on an exterior surface of the plurality of funnels to allow for robotic pickup.

8. The automated solution maker system of claim 1, wherein the adjustable opening is between 0 inches and 2 inches.

9. The automated solution maker system of claim 1, further comprising:
a user input device configured to receive one or more user inputs, wherein the one or more user inputs include the one or more solution parameters.

10. The automated solution maker system of claim 9, wherein the user input device includes a touchscreen user interface coupled to a portion of the structural housing, wherein the touchscreen user interface includes one or more selectable buttons to allow a user to input the one or more solution parameters, wherein the touchscreen user interface is configured to display at least one of one or more flow parameters, one or more weight measurements, or one or more system diagnostics.

11. An automated solution maker system comprising:
a structural housing including at least one of a base, a top lid, one or more side casings, a front casing, and a back casing, wherein the base of the structural housing is configured to receive a solution collection vessel,
a magnetic stirring assembly, wherein the magnetic stirring assembly includes an integrated scale within a housing of the magnetic stirring assembly, wherein the integrated scale is configured to weigh one or more materials within the solution collection vessel, wherein the magnetic stirring assembly includes a hot plate configured to heat the one or more materials within the solution collection vessel, wherein the magnetic stirring assembly includes a magnetic stirring base member disposed on the base;
a plurality of funnels positioned to dispense directly into the solution collection vessel, wherein the plurality of funnels include at least one powder funnel designated for a powdered material and at least one liquid funnel designated for a liquid material, wherein the at least one powder funnel includes an auger and a motor, wherein the motor of the at least one powder funnel is configured to control a powder flow of the powdered material, wherein each funnel of the plurality of funnels includes a removable lid, wherein the removable lid includes one or more magnetic sheets arranged to allow for robotic pickup, wherein each funnel of the plurality of funnels includes one or more additional magnetic sheets arranged on an exterior surface of the plurality of funnels to allow for robotic pickup, wherein the auger and the motor of the at least one powder funnel are integrated into the removable lid of the at least one powder funnel;
a funnel holder configured to support the plurality of funnels, wherein the funnel holder is mounted to a portion of the structural housing; and
one or more diaphragms positioned below each funnel of the plurality of funnels, wherein the one or more diaphragms include an adjustable opening and a diaphragm motor, wherein the one or more diaphragms are configured to regulate a discharge of the one or more materials through the adjustable opening.

12. The automated solution maker system of claim 11, further comprising:
one or more controllers communicatively coupled to the magnetic stirring assembly and the one or more diaphragms, wherein the one or more controllers include a proportional-integral-derivative (PID) algorithm stored in memory wherein the one or more controllers include one or more processors configured to execute a set of program instructions causing the one or more processors to:
receive one or more solution parameters;
generate one or more control signals configured to cause the adjustable opening of the one or more diaphragms to open a predetermined amount;
receive a real-time weight of the one or more materials within the solution collection vessel; and
generate one or more control signals configured to cause the magnetic stirring assembly to mix the one or more materials within the solution collection vessel.

13. The automated solution maker system of claim 12, wherein the one or more controllers are further configured to:
dispense the powdered material based on the PID algorithm, wherein the PID algorithm is based on the one or more solution parameters received, wherein the one or more solution parameters include at least one of a powder mass, PID constants, an auger speed, a bulk density, and a screw geometry.

14. The automated solution maker system of claim 12, wherein the one or more controllers are further configured to:
dispense the liquid material based on the PID algorithm, wherein the PID algorithm is based on the one or more solution parameters received, wherein the one or more solution parameters include at least one of a predetermined mass, PID constants, a predetermined volume, a fluid density, or one or more funnel dimensions.

15. The automated solution maker system of claim 12, wherein the one or more controllers are further configured to:
perform a closed-loop control using the PID algorithm stored in the memory based on real-time mass feedback from the integrated scale to dynamically adjust one of an aperture size of the adjustable opening of the at least one powder funnel and the at least one liquid funnel or an auger speed of the at least one powder funnel.

16. The automated solution maker system of claim 12, further comprising:
a user input device configured to receive one or more user inputs, wherein the one or more user inputs include the one or more solution parameters, wherein the user input device includes a touchscreen user interface coupled to a portion of the structural housing, wherein the touchscreen user interface includes one or more selectable buttons to allow a user to input the one or more solution parameters, wherein the touchscreen user interface is configured to display at least one of one or more flow parameters, one or more weight measurements, or one or more system diagnostics.

17. A method comprising:
receiving one or more user inputs, wherein the one or more user inputs includes one or more solution parameters, wherein the one or more solution parameters include at least one of a powder mass, PID algorithm constants, an auger speed, a bulk density, a screw geometry, a material compressibility, a predetermined mass, a predetermined volume, a fluid density, a viscosity, or one or more funnel dimensions;
dispensing, individually, one or more materials within a plurality of funnels into a solution collection vessel, wherein the plurality of funnels include at least one powder funnel designated for a powdered material and at least one liquid funnel designated for a liquid material, wherein the at least one powder funnel includes an auger and a motor, wherein the motor of the at least one powder funnel is configured to control a powder flow of the powdered material;
weighing, individually, the one or more materials dispensed in the solution collection vessel using an integrated scale of a magnetic stirring assembly;
activating a magnetic stirrer of the magnetic stirring assembly; and
performing a closed-loop control using a proportional-integral-derivative algorithm stored in memory based on real-time mass feedback from the built-in scale to dynamically adjust one of an aperture size of an adjustable opening or an auger speed of the auger of the at least one powder funnel.

18. The method of claim 17, further comprising:
dispensing the powdered material via the at least one powder funnel, wherein the one or more solution parameters received include at least one of a powder mass, PID constants, an auger speed, a bulk density, and a screw geometry.

19. The method of claim 17, further comprising:
dispensing the liquid material via the at least one liquid funnel, wherein the one or more solution parameters received include at least one of a predetermined mass, PID constants, a predetermined volume, a fluid density, or one or more funnel dimensions.
